(19) United States
(12) Patent Application Publication
(10) Pub. No.: US 2006/0045456 A1
(43) Pub. Date: Mar. 2, 2006

(54) POLARIZATION CONVERSION LIGHT PIPE DEVICE

(76) Inventors: Po Liang Chiang, Taipei City (TW); Yi Wei Liu, Taipei Hsien (TW); Hsin Wen Tsai, Taipei Hsien (TW); Hsueh Chen Chang, I-Lan Hsien (TW); Ci Guang Peng, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 10/711,177

(22) Filed: Aug. 30, 2004

(51) Int. Cl. G02B 6/27

(52) U.S. Cl. 385/133; 385/11

(57) ABSTRACT

This invention provides a polarization conversion light pipe device suited for LCD- or LCoS-based projection applications. The polarization conversion light pipe device encompasses a light tunnel defined by four side reflection mirrors with a rectangular cross section. The light tunnel has a light entrance face at one end and a light exit face at the other end. A front reflection mirror having an aperture thereon is mounted on the light entrance face. A retardation plate for rotating the direction of an electric field of a polarized light beam is situated in the light tunnel. A polarization beam splitter module is situated between the exit face of the light tunnel and the retardation plate. The polarization beam splitter module has a reflective polarization beam splitting surface that is substantially 45 degree-inclined with respect to one of the side reflection mirrors.

### BACKGROUND OF INVENTION

1. Field of the Invention

The present invention generally relates to an optical device for polarization conversion, and more particularly to a high performance polarization conversion light pipe device suited for LCD- or LCoS-based projectors.

2. Description of the Prior Art

Liquid Crystal Display (LCD) projectors are known in the art and are broadly classified into two types, one type being a transmission-type LCD in which a desired display is achieved by observing, from a side of the facing substrate, light incident on the liquid crystal from a side of the TFT substrate and another being a reflective-type LCD such as a LCoS projector in which a desired display is achieved by having light incident on the liquid crystal from the side of the facing substrate reflect on the side of the reflective substrate and by causing the light to be emitted from the side of the facing substrate.

As well known by those skilled in the art, light is a kind of electromagnetic wave that, in addition to having the characteristics of direction of travel, frequency, and phase, etc., also has a polarization. Light with a fixed direction of electric field oscillation and a direction of magnetic field oscillation is known as polarized light. Where the polarized light has an electric field direction parallel or perpendicular to an incident light ray, the same is referred to as P-polarized light or S-polarized light. As polarized light occurs only in a plane and can be interpreted by using mathematical models, it provides facility in use. Therefore, in a conventional projection display system, a light polarization state converter is often employed to convert the polarization state of light from one to the other for optimum utilization of light rays.

Generally, a conventional illumination module for LCD projectors or LCoS projectors includes a lamp, a reflector, an integrator, and a Polarization Beam Splitter (PBS) array. The PBS array may transform P-polarized light into S-polarized light. However, the PBS array is expensive and is not efficient at light polarization conversion.

Challenges presented by the conventional projector device (in seeking to project a clear image onto an entire projection screen) include reduction of non-uniformity in illumination by light from a light source and high intensity of an optical output. To meet these challenges, a prism-shaped transparent member, commonly called a polarization conversion light pipe, is used to enable uniform application of the above condensed light.

FIG. 1 is a schematic cross-sectional view illustrating a prior art polarization conversion light pipe device 10 that is capable of polarizing light and providing more efficient use of light from a lamp. The polarization conversion light pipe device 10 includes a hollow light tunnel 14 constituted by reflective mirrors 12, and a reflective mirror 18 situated at the entrance face 16. The reflective mirror 18 includes an aperture 20 that allows light beam 22 emanated from a light source to enter the light tunnel 14. The incident light beam 22 passes through a quarter-wavelength plate (QWP) 24 located near the entrance face 16, and then reflected by the reflective mirrors 12. A reflective polarizer 28 is situated at an exit face 26 of the light tunnel 14. The reflective polarizer 28 allows light 32 of a first polarization state to pass therethrough, and reflects light 34 of a second polarization state back into the light tunnel 14. Light 34 reflected by the reflective polarizer 28 passes through the QWP 24 twice and thus being transformed into light 36 of the first polarization state.

However, the above-described prior art polarization conversion light pipe device 10 has several drawbacks. First, the arrangement that the reflective polarizer 28 being affixed directly on the exit face 26 of the light tunnel 14 leads to poor extinction ratio. The details of this adhesion problem are not yet sufficiently clear or complete to those skilled in the art. It is believed that the problem of poor extinction ratio exists due to the glue or bonding material applied to the interface between the reflective mirrors 12 and the reflective polarizer 28 interferes a portion of the passing polarized light, thereby generating noise.

Further, since the reflective polarizer 28 is typically located on the exit face 26, which is also the image-forming plane, very high degree of surface cleanliness of the reflective polarizer 28 is therefore required. To meet this strict surface cleanliness requirement, an additional and costly high-quality optical mask is usually equipped thereto so as to keep the reflective polarizer 28 from dusts, particles or scratches. Plus, the optical mask also occupies valuable assembly space, thus limits the miniaturization of the projector systems.

### SUMMARY OF INVENTION

Accordingly, it is the primary object of the present invention to provide an improved polarization conversion light pipe device suited for the LCD- or LCoS-based projection systems, which is capable of solving the above-described problems.

It is another object of the present invention to provide an improved polarization conversion light pipe device suited for the LCD- or LCoS-based projection systems, which is capable of providing high purity polarized light output and improving use of light from a lamp.

According to the claimed invention, a polarization conversion light pipe device suited for LCD- or LCoS-based projection systems is provided. The polarization conversion light pipe device comprises a light tunnel defined by four side reflective mirrors, wherein the light tunnel has a rectangular cross section and has a light entrance face and a light exit face. A front reflective mirror is mounted at the light entrance face, wherein the front reflective mirror has an aperture where light emanated from a light source is condensed thereto and enters the light tunnel. A retardation plate is situated within the light tunnel. A polarization beam splitter module comprising at least one polarization beam splitting surface that is substantially 45 degree-inclined with respect to one of the side reflection mirrors is located within the light tunnel between the retardation plate and the light exit face.

Other objects, advantages, and novel features of the claimed invention will become more clearly and readily apparent from the following detailed description when taken in conjunction with the accompanying drawings.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic cross-sectional view illustrating a prior art polarization conversion light pipe device;

FIG. 2 is a perspective schematic view illustrating a polarization conversion light pipe device according to the first preferred embodiment of the present invention;

FIG. 3 is a schematic cross-sectional view of the polarization conversion light pipe device as set forth in FIG. 2;

FIG. 4 is a schematic cross-sectional view illustrating a polarization conversion light pipe device according to the second preferred embodiment of the present invention;

FIG. 5 is a schematic cross-sectional view illustrating a polarization conversion light pipe device according to the third preferred embodiment of the present invention;

FIG. 6 is a schematic cross-sectional view illustrating a polarization conversion light pipe device according to the fourth preferred embodiment of the present invention; and

FIG. 7 is a schematic cross-sectional view illustrating a polarization conversion light pipe device according to the fifth preferred embodiment of the present invention;

### DETAILED DESCRIPTION

The present invention is directed to a polarization conversion light pipe device that may be installed in a LCD- or LCoS-based projection display system. The polarization conversion light pipe device of the present invention is employed to convert the polarization state of light from one to the other for optimum utilization of light rays.

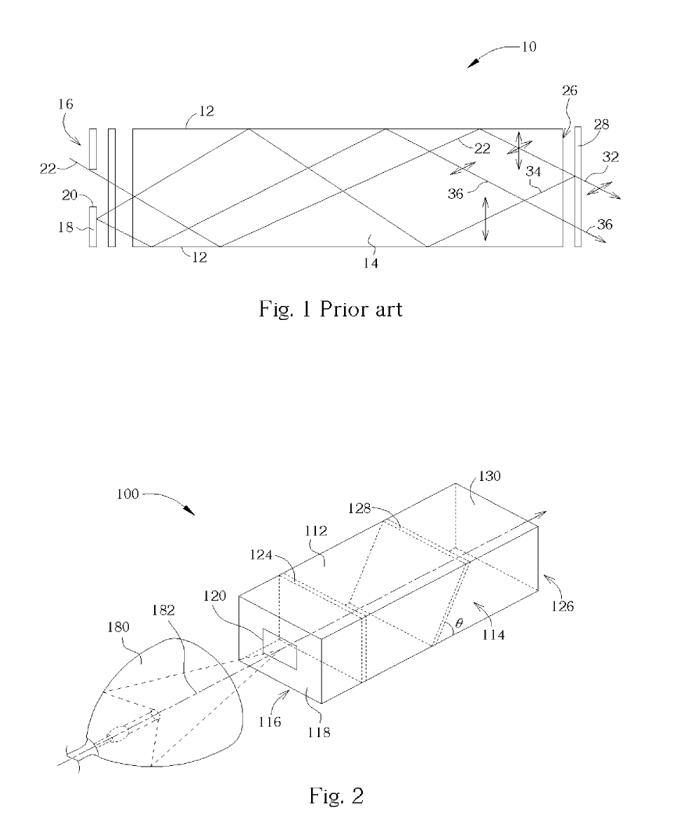

Referring to FIG. 2, a polarization conversion light pipe device 100 according to the first preferred embodiment of the present invention is demonstrated in perspective view. The polarization conversion light pipe device 100 is mounted in front of a lamp 180 having an elliptic plane mirror. The lamp 180, such as an arc lamp or high-pressure mercury lamp, has an elliptic major axis 182. The polarization conversion light pipe device 100 is situated on the light path of the projection system and is aligned with the elliptic major axis 182.

Light emanated from the first focus point is condensed by the elliptic plane mirror to the second focus point at an incident angle α with respect to the elliptic major axis 182. As shown in FIG. 2, the polarization conversion light pipe device 100 comprises a hollow light tunnel 114 defined by side reflective mirrors 112, and a reflective mirror 118 mounted at the entrance face 116 of the hollow light tunnel 114. The reflective mirror 118 has an aperture 120 that is located right on the aforesaid second focus point where light is condensed thereto. As specifically indicated in FIG. 2, light condensed on the aperture 120 enters the light tunnel 114.

The cross section of the light tunnel 114 is substantially rectangular and is similar to a shape of a projection screen. The entrance face 116 of the polarization conversion light pipe device 100 is close to the lamp 180. The polarization conversion light pipe device 100 has the other end, exit face 126, serving as a light outgoing face. The present invention features that the image forming surface 130 is totally “clear” since there is no physical optical object mounted on the image forming surface 130 or on the exit face 126, such that a better image forming quality is obtained without the fear of dusts, particles or scratches.

The polarization conversion light pipe device 100 further comprises a retardation plate 124 for rotating the direction of an electric field of a polarized light beam. A polarization beam splitter module 128 is situated within the light tunnel 114 having a polarization beam splitting surface with an oblique angle θ with respect to the elliptic major axis 182. The polarization beam splitter module 128 is situated between the retardation plate 124 and the exit face 126 of the light tunnel 114. The oblique angle θ is about 45°. That is, the polarization beam splitter module 128 has a polarization beam splitting surface that is substantially 45 degree-inclined with respect to one of the side reflection mirrors. Preferably, the polarization beam splitter module 128 is closer to the retardation plate 124 for generating better quality images. It is advantageous to use the present invention because a costly high-quality optical mask for protecting a reflective polarizer is no longer necessary.

In accordance with the first preferred embodiment of the present invention, the polarization beam splitter module 128 is a wire grid polarizer with high extinction ratio and low reflection losses. As known in the art, a wire grid polarizer contains fine silver or aluminum wire grids closely arranged at very small pitches on a transparent glass along the same direction, which is hereinafter referred to as “grid direction”. The polarization beam splitter module 128 may be a conventional reflective polarizer. Taking the wire grid polarizer as an example, the polarized light having an electric field direction that is perpendicular to the grid direction of the wire grid polarizer (referred to as “vertical” polarized light) passes through the wire grid polarizer and is propagated to the exit face 126, while one the other hand, the polarized light having an electric field direction that is parallel to the grid direction of the wire grid polarizer (referred to as “parallel” polarized light) is reflected by the wire grid polarizer back to the light tunnel 114.

The phase of the light reflected by the polarization beam splitter module 128 is then converted by the retardation plate 124. In accordance with the first preferred embodiment of the present invention, the retardation plate 124 may be a quarter-wavelength plate or the like.

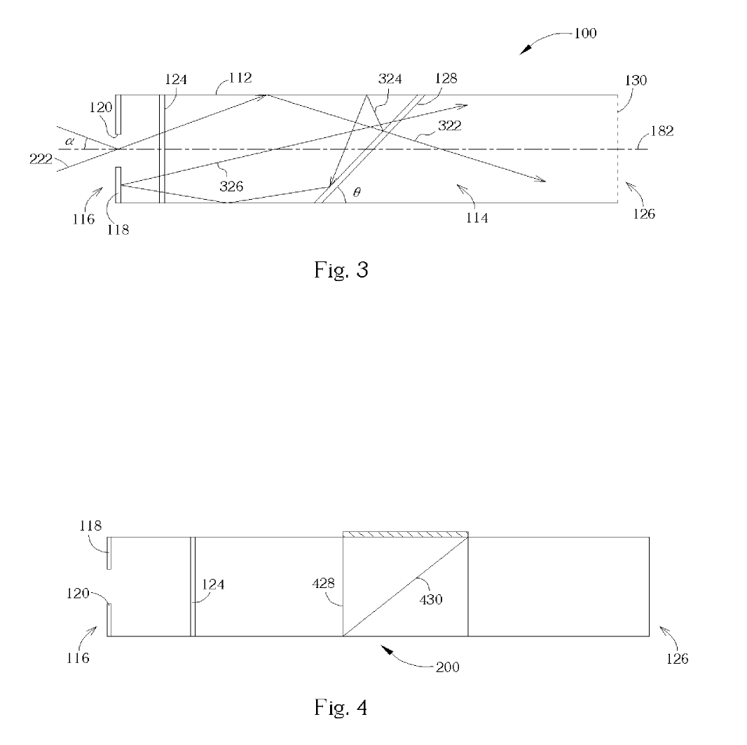

Referring to FIG. 3, a schematic cross-sectional view of the polarization conversion light pipe device 100 as set forth in FIG. 2 is demonstrated. By way of example, an un-polarized light beam 222 emanated from a light source passes through the aperture 120 and enters the light tunnel 114. The un-polarized light beam 222 first passes through the retardation plate 124 and is then reflected and re-directed by side mirror 112 to the polarization beam splitter module 128. As mentioned, “vertical” polarized light 322 of the light beam 222 passes through the polarization beam splitter module 128, while the “parallel” polarized light 324 of the light beam 222 is reflected by the polarization beam splitter module 128 to side mirror 112, and again reflected back to the polarization beam splitter module 128, and then reflected to another side mirror 112 and reflective mirror 118, then re-directed to the retardation plate 124. Light beam 324 reflected by the polarization beam splitter module 128 passes through the QWP 124 twice and thus being converted into light beam 326 of a polarization state that is the same as that of light 322.

In the above-described example, it is noteworthy that the “parallel” polarized light 324 is reflected twice by the polarization beam splitter module 128 before being propagated through the retardation plate 124. The two-time reflection on the polarization beam splitter module 128 promote purity of outputting light, thereby improving the extinction ratio of the projection system.

In accordance with the spirit and purposes of the present invention, the polarization beam splitter module 128 may also be replaced with other like optical devices having different configurations. Several preferred practical examples are given and explained with reference to FIG. 4 to FIG. 7.

Referring to FIG. 4, a schematic cross-sectional view illustrating a polarization conversion light pipe device 200 according to the second preferred embodiment of the present invention is demonstrated. Likewise, the polarization conversion light pipe device 200 comprises a hollow light tunnel 114 defined by side reflective mirrors 112, and a reflective mirror 118 mounted at the entrance face 116 of the hollow light tunnel 114. The reflective mirror 118 has an aperture 120 that is located right on the aforesaid second focus point where light is condensed thereto. Light condensed on the aperture 120 enters the light tunnel 114. The polarization conversion light pipe device 200 further comprises a retardation plate 124 for rotating the direction of an electric field of a polarized light beam. A polarization beam splitter module 428 is situated within the light tunnel 114 having a polarization beam splitting surface with an oblique angle θ with respect to one of the side reflective mirrors 112. According to the second preferred embodiment, the polarization beam splitter module 428 is a prism cube consisting of two 90-45-45 degree symmetric triangle prisms. On the 45-degree surface of one of the triangle prisms, a beam splitting coating 430 is coated thereon. The beam splitting coating 430 allows light of one polarization state to pass therethrough, but reflects light of the other polarization state.

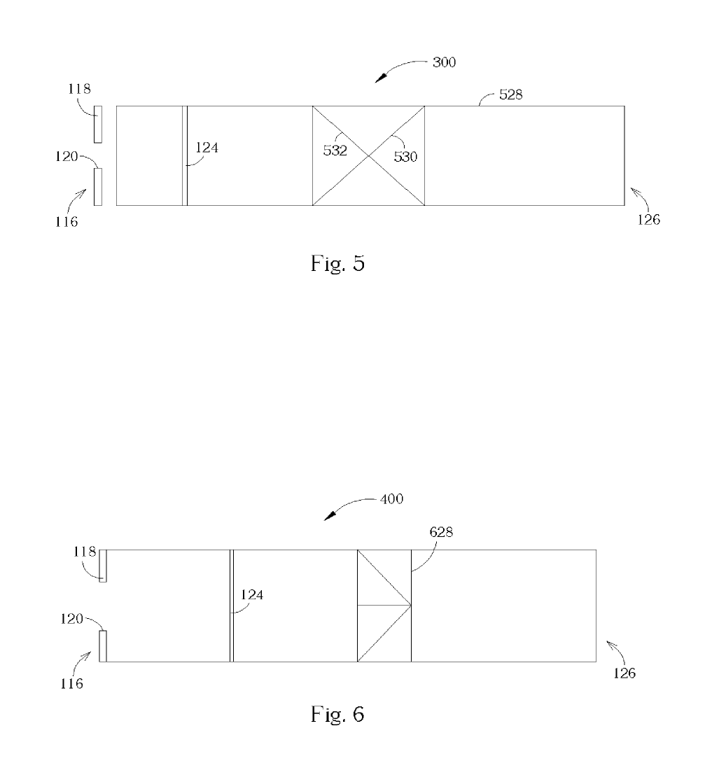

Referring to FIG. 5, a schematic cross-sectional view illustrating a polarization conversion light pipe device 300 according to the third preferred embodiment of the present invention is demonstrated. The polarization conversion light pipe device 300 comprises a hollow light tunnel 114 defined by side reflective mirrors 112, and a reflective mirror 118 mounted at the entrance face 116 of the hollow light tunnel 114. The reflective mirror 118 has an aperture 120 that is located right on the aforesaid second focus point where light is condensed thereto. Light condensed on the aperture 120 enters the light tunnel 114. The polarization conversion light pipe device 300 further comprises a retardation plate 124 for rotating the direction of an electric field of a polarized light beam. A polarization beam splitter module 528 is situated within the light tunnel 114. According to the third preferred embodiment, the polarization beam splitter module 528 is a PBS module with two orthogonal arranged beam splitting coatings 530 and 532, wherein the beam splitting coatings 530 and 532 allow light of one polarization state to pass therethrough, but reflect light of the other polarization state.

Referring to FIG. 6, a schematic cross-sectional view illustrating a polarization conversion light pipe device 400 according to the fourth preferred embodiment of the present invention is demonstrated. The polarization conversion light pipe device 400 comprises a hollow light tunnel 114 defined by side reflective mirrors 112, and a reflective mirror 118 mounted at the entrance face 116 of the hollow light tunnel 114. The reflective mirror 118 has an aperture 120 that is located right on the aforesaid second focus point where light is condensed thereto. Light condensed on the aperture 120 enters the light tunnel 114. The polarization conversion light pipe device 300 further comprises a retardation plate 124 for rotating the direction of an electric field of a polarized light beam. A polarization beam splitter module 628 is situated within the light tunnel 114. According to the fourth preferred embodiment, the polarization beam splitter module 628 is a typical PBS module.

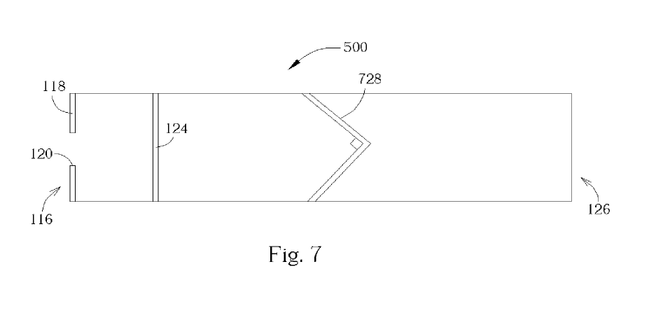

Referring to FIG. 7, a schematic cross-sectional view illustrating a polarization conversion light pipe device 500 according to the fifth preferred embodiment of the present invention is demonstrated. The polarization conversion light pipe device 500 comprises a hollow light tunnel 114 defined by side reflective mirrors 112, and a reflective mirror 118 mounted at the entrance face 116 of the hollow light tunnel 114. The reflective mirror 118 has an aperture 120 that is located right on the aforesaid second focus point where light is condensed thereto. Light condensed on the aperture 120 enters the light tunnel 114. The polarization conversion light pipe device 300 further comprises a retardation plate 124 for rotating the direction of an electric field of a polarized light beam. A polarization beam splitter module 728 is situated within the light tunnel 114. According to the fifth preferred embodiment, the polarization beam splitter module 728 is a 90-degree folded PBS plate.

Those skilled in the art will readily observe that numerous modifications and alterations of the present invention method may be made while retaining the teachings of the invention. For example, in another case, the retardation plate may be adhered to the polarization beam splitter module. Accordingly, the above disclosure should be construed as limited only by the metes and bounds of the appended claims.

What is claimed is:

1. A polarization conversion light pipe device suited for LCD- or LCoS-based projection systems, the polarization conversion light pipe device comprising:
a light tunnel defined by four side reflective mirrors, wherein the light tunnel has a rectangular cross section and has a light entrance face and a light exit face;
a front reflective mirror mounted at the light entrance face, wherein the front reflective mirror has an aperture where light emanated from a light source is condensed thereto and enters the light tunnel;
a retardation plate situated within the light tunnel; and
a polarization beam splitter module comprising at least one polarization beam splitting surface that is substantially 45 degree-inclined with respect to one of the side reflection mirrors, wherein the polarization beam splitter module is located within the light tunnel between the retardation plate and the light exit face.

2. The polarization conversion light pipe device according to claim 1 wherein the retardation plate rotates direction of an electric field of an incident polarized light.

3. The polarization conversion light pipe device according to claim 1 wherein the polarization beam splitter module is a wire grid polarizer.

4. The polarization conversion light pipe device according to claim 1 wherein the polarization beam splitter module comprises a polarization beam splitter (PBS) element.

5. The polarization conversion light pipe device according to claim 4 wherein the PBS element comprises a 90-45-45 degree triangle prism.

6. The polarization conversion light pipe device according to claim 1 wherein the retardation plate is adhered to the polarization beam splitter module.
